(19) United States
(12) Patent Application Publication
(10) Pub. No.: US 2004/0219333 A1
(43) Pub. Date: Nov. 4, 2004

(54) Imitation wood component and method of producing the imitation wood component

(75) Inventors: Hans Peter Baumann, Haibach (DE); Herbert Halbleib, Obernau (DE)

Correspondence Address: TAROLLI, SUNDHEIM, COVELL, TUMMINO & SZABO, L.L.P., 1111 LEADER BLDG., 526 SUPERIOR AVENUE, CLEVELAND, OH, 44114-1400, US

(73) Assignee: TRW Automotive Safety Systems GmbH

(21) Appl. No.: 10/833,523

(22) Filed: Apr. 28, 2004

(30) Foreign Application Priority Data
Apr. 30, 2003 (DE) 203 06 729.0

(51) Int. Cl. B32B 9/00

(52) U.S. Cl. 428/151

(57) ABSTRACT

In a method of producing an imitation wood component firstly a starting component is provided which has a surface area to be processed, onto which an adhesion layer is applied. After drying of the adhesion layer at least one coat of lacquer of wooden color is applied to the adhesion layer and spread by using a textile cloth in order to produce an optical structure looking like wood. After drying of the coat of lacquer, a protective layer is applied which again has to dry. A component is made by this method, the properties of which are remarkably like those of natural wood. Using natural wood parts can be dispensed with, leading to a reduced consumption of wood and, hence, to a sparing of natural resources.

### FIELD OF THE INVENTION

The present invention relates to imitation wood components and a method of producing such components.

### TECHNICAL BACKGROUND

It is for environmental reasons and sparing the natural resources that more and more products of naturally grown wood are replaced by imitations of wood. Wood imitation products are to have properties in terms of their visual appearance and haptics which come as close as possible to those of natural wood products. In order to achieve this, there is a multiplicity of techniques which, however, partly require a very high technical and financial expenditure. Due to this fact the production of imitation wood products is often up to companies with special know-how, which then deliver these products in the form of semi-finished products to further-processing enterprises.

### SUMMARY OF THE INVENTION

It is therefore an object of the present invention to provide a product which has properties in terms of visual appearance and haptics that are very close to those of natural wood, and which at the same time is simply to produce and attractively priced.

According to the invention, the imitation wood component is produced by a method comprising the steps described below. At first a starting component is provided which has a surface area to be processed, onto which an adhesion layer is applied. After drying of the adhesion layer at least one coat of lacquer of wooden color is applied to the adhesion layer and spread by using a textile cloth in order to produce an optical structure looking like wood. After drying of the coat of lacquer, a protective layer is applied which again has to dry. A component is made by this method, the properties of which are remarkably like those of natural wood. Using natural wood parts can be dispensed with, leading to a reduced consumption of wood and, hence, to a sparing of natural resources.

Basically all components having a plastic or metal surface are suitable as starting component for such a method.

### DESCRIPTION OF PREFERRED EMBODIMENTS

The method of producing the imitation wood component consists in subsequent steps of applying, spreading and drying various coats of lacquers. As there already exist lacquering techniques in many production fields, it is easily possible to integrate the method of producing the imitation wood components in existing process runs in the own enterprise. With this it is possible to do without the supply of imitation wood components by special companies, this reducing the dependency on the supporting industry and allowing a more rapid manufacturing as a whole.

In one preferred embodiment applying and spreading the coat of lacquer on the adhesion layer is carried out in two subsequent steps, the first step consisting in applying the coat of lacquer to the adhesion layer and the second step consisting in spreading the coat of lacquer by using the textile cloth. In this manner the coat of lacquer can be applied by conventional spraying methods, for example, and then spread by using an appropriately structured textile cloth, e.g. a fabric, to produce a surface similar to wood.

In a further preferred embodiment applying and spreading the coat of lacquer on the adhesion layer is carried out in one step, the coat of lacquer being applied to the adhesion layer by means of the textile cloth. In this case an appropriately structured textile cloth is supplied with lacquer by means of a suitable distribution system, this lacquer being applied to the adhesion layer by a suitable method, for instance by dabbing on. The advantage of such method is that only one working step is required, achieving a further saving of time.

The imitation wood components according to the invention can be used in particular in the production of motor vehicles. Thus, steering wheels, covering caps, airbag modules, shields and linings of all kinds in high-quality motor vehicles are delivered in wood-like appearance.

Steering wheels covered with wood present a special case. Due to the small radii of curvature of the surfaces of a steering wheel the expenditure for producing a wooden surface is particularly high with these elements. As a rule, laminated and milled wooden shells are produced which then have to be applied to the steering wheel body and fastened thereto.

According to the invention, a steering wheel body of plastic, metal or a combination of these materials (e.g. a metal skeleton embedded in polyurethane foam) can be employed as starting component for the method proposed, and then further processed according to the method steps set out above. It turned out that for best results the final step of drying the protective layer should be carried out for 20 minutes in an oven at a temperature of about 50° C. Depending on the desired surface quality, the process of applying and drying the protective layer is to be carried out several times, if applicable. It is by means of this method that a steering wheel looking as if made of wood can be produced with a high-quality appearance and in a very simple, quick and attractively priced manner.

1. A method of producing an imitation wood component, comprising the steps of:
providing a starting component having a surface area to be processed;
applying an adhesion layer to the surface area to be processed;
drying the adhesion layer;
applying and spreading at least one coat of lacquer of wooden color to the adhesion layer by using a textile cloth in order to produce an optical structure looking like wood;
drying the coat of lacquer;
applying a protective layer;
drying the protective layer.

2. The method according to claim 1, characterized in that applying and spreading the coat of lacquer on the adhesion layer is carried out in two subsequent steps, the first step consisting in applying the coat of lacquer to the adhesion layer and the second step consisting in spreading the coat of lacquer by using the textile cloth.

3. The method according to claim 1, characterized in that applying and spreading the coat of lacquer on the adhesion layer is carried out in one step, the coat of lacquer being applied to the adhesion layer by means of the textile cloth.

4. The method according to claim 1, characterized in that the starting component is a steering wheel for a motor vehicle.

5. An imitation wood component for use as a steering wheel in vehicles, obtainable by a method according to claim 1.
